(19) United States
(12) Patent Application Publication
(10) Pub. No.: US 2026/0090336 A1
(43) Pub. Date: Mar. 26, 2026

(54) AI-Optimized Semiconductor Manufacturing Process Using Machine Learning Models Trained on Mask Work Datasets

(71) Applicant: Alexander Davis, Oxnard, CA (US)

(72) Inventor: Alexander Davis, Oxnard, CA (US)

(21) Appl. No.: 18/890,840

(22) Filed: Sep. 20, 2024

(51) Int. Cl. H01L 21/66; G06F 30/27; G06F 119/18

(52) U.S. Cl. CPC H10P 74/238; G06F 30/27; H10P 74/203; G06F 2119/18

(57) ABSTRACT

A method and system for optimizing a semiconductor manufacturing process using an artificial intelligence (AI) system comprising machine learning (ML) models trained on mask work datasets. The AI system generates optimized process parameters for a multi-step semiconductor manufacturing process based on an input mask work. The manufacturing process includes photolithography, etching, ion implantation, chemical vapor deposition (CVD), physical vapor deposition (PVD), atomic layer deposition (ALD), thermal oxidation, and/or chemical-mechanical polishing (CMP). During manufacturing, metrology data is collected and input into the ML models to predict end-of-line electrical performance parameters. If the predicted parameters deviate from target values, the AI system adjusts process parameters to optimize performance. The ML models are retrained using the collected metrology data to improve AI system performance over time. The system includes a semiconductor manufacturing apparatus configured to perform the optimized manufacturing process.

### BACKGROUND OF THE INVENTION

### Field of Invention

The present disclosure relates to the field of semiconductor device manufacturing. More particularly, it relates to using artificial intelligence to optimize process parameters in semiconductor fabrication to improve end-of-line electrical performance.

### Description of Related Art

Semiconductor devices are manufactured through a complex multi-step process involving photolithography, etching, deposition, chemical-mechanical polishing, and various other techniques. Optimizing the numerous process parameters across these many steps to achieve the desired electrical performance in the final device is a significant challenge in the industry. Conventional approaches rely heavily on time-consuming and costly experimental wafer runs and physical measurements.

Furthermore, the increasing complexity of semiconductor devices, such as those involving curvilinear patterns, adds to the difficulty of process optimization. Existing methods often fail to adequately model and optimize the fabrication processes for these intricate designs. This leads to suboptimal electrical performance in the manufactured devices.

Accordingly, there is a need in the art for improved systems and methods to optimize semiconductor manufacturing process parameters. Specifically, solutions that can intelligently generate optimized settings and adapt to complex device patterns are required. Additionally, there is a need for techniques that can accurately predict end-of-line electrical performance and adjust process parameters during manufacturing to further optimize the results.

### BRIEF SUMMARY OF THE INVENTION

This summary is provided to introduce a selection of concepts, in a simplified format, that are further described in the detailed description of the invention. This summary is neither intended to identify key or essential inventive concepts of the invention nor is it intended for determining the scope of the invention.

The present disclosure provides systems and methods for optimizing semiconductor device manufacturing using artificial intelligence (AI). In one aspect, a mask work defining a pattern for a semiconductor device is input into an AI system comprising machine learning (ML) models trained on mask works and optimized process parameters. The AI system generates optimized parameters for a multi-step manufacturing process, which may include photolithography, etching, deposition, chemical-mechanical polishing (CMP), and various other steps.

Advantageously, the AI-generated process parameters enable the manufacturing of semiconductor devices with improved end-of-line electrical performance. During fabrication, metrology data is collected and input into the ML models to predict final electrical parameters such as threshold voltage, leakage current, and operating frequency. If deviations from target performance are identified, the system dynamically adjusts process parameters to optimize the results.

The AI system of the present invention solves the problems associated with conventional process optimization by using intelligent models to efficiently generate recipes adapted to complex device patterns, including curvilinear designs. The system further provides the benefit of real-time in-line metrology to detect and correct performance issues during manufacturing.

In preferred embodiments, the ML models are trained on datasets covering a range of mask works and optimized process parameters across the multi-step manufacturing flow. The system may interface with a variety of fabrication tools used for different process steps. Retraining the models with newly collected metrology data enables continuous learning and improvement.

Additional aspects of the invention include simulating the manufacturing process with AI-generated parameters to predict performance, identifying root causes of deviations, and recommending corrective actions. Post-fabrication, the system may further include wafer electrical testing, die preparation, and final device packaging.

The ability to automatically optimize semiconductor manufacturing using AI has the potential for significant industry impact in terms of improving chip performance, yield, efficiency, and cost-effectiveness.

Additional features and advantages of the invention will be set forth in the description which follows. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a schematic block diagram illustrating a system for optimizing a semiconductor device manufacturing process, according to one embodiment.

FIG. 2 illustrates a machine learning training process for optimizing a semiconductor manufacturing process, according to one embodiment.

FIG. 3 illustrates a schematic diagram of a user interface for interacting with the system of FIG. 1 to optimize a semiconductor device manufacturing process, according to one embodiment.

FIG. 4 illustrates a method that may be employed for optimizing a semiconductor device manufacturing process using the system of FIG. 1 via the user interface of FIG. 3, according to one embodiment.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

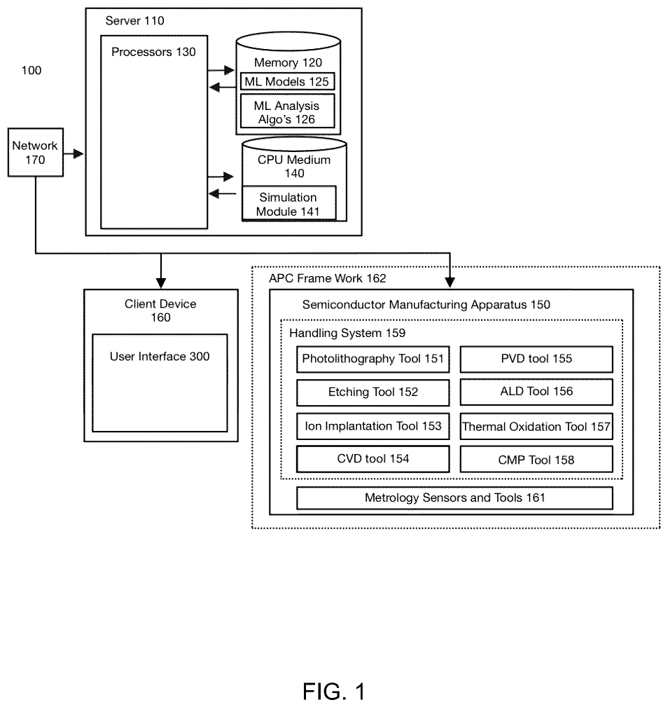

FIG. 1 is a schematic block diagram illustrating a system 100 for optimizing a semiconductor device manufacturing process. As shown in FIG. 1, the system 100 generally comprises a user interface 300, a memory 120 storing one or more machine learning (ML) models 125, one or more processors 130, a non-transitory computer-readable medium 140 storing instructions, and a semiconductor manufacturing apparatus 150.

In one embodiment, the user interface 300 hosted on a client device 160 may be configured to receive a mask work defining a pattern for a semiconductor device. The mask work can be received from the client device 160 over a network 170, wherein said network 170 might be, by way of example and not limitation, the Internet, a local area network (LAN), a wide area network (WAN), or any other suitable communication network. The client device 160 typically includes a user interface 300, such as a graphical user interface (GUI), for uploading the mask work to the system 100. In another embodiment, the user interface 300 may include input devices, including but not limited to a keyboard, mouse, touchscreen, or any other suitable input device, and output devices, such as a display, printer, or any other suitable output device. According to an embodiment, the user interface 300 is further configured to optionally receive a mask set defining multiple layers of the semiconductor device, such as, by way of example and not limitation, a diffusion layer, a polysilicon layer, a metal layer, or any other suitable layer.

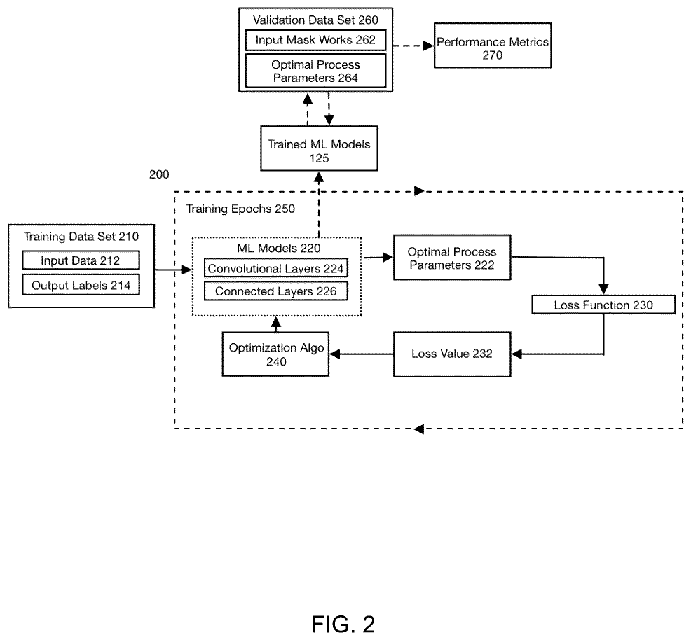

In FIG. 1, the memory 120 stores the one or more ML models 125 trained on a dataset of mask works and corresponding optimized manufacturing process parameters (further detailed in FIG. 2). The dataset generally includes data related to at least one of cleaning, photoresist coating, photoresist baking, exposure, ion implantation, etching, chemical vapor deposition (CVD), physical vapor deposition (PVD), thermal treatments, or chemical-mechanical polishing (CMP). For example, the dataset may include, but is not limited to, data related to the type and concentration of cleaning agents, the spin speed and time for photoresist coating, the temperature and duration of photoresist baking, the wavelength and dose of exposure, the type and energy of ion implantation, the type and concentration of etching agents, the precursor gases and deposition parameters for CVD and PVD, the temperature and duration of thermal treatments, and the slurry composition and polishing parameters for CMP. It is understood in the art that such values may change per configuration of the device in different settings. In one embodiment, the dataset also optionally includes end-of-line electrical performance parameters associated with the mask works and optimized process parameters, such as, by way of example and not limitation, the threshold voltage, on-current, off-current, subthreshold slope, and any other suitable electrical performance parameter.

According to an embodiment, the one or more ML Models 125 are configured to generate optimized process parameters for various types of photomasks, including but not limited to binary photomasks, attenuated phase-shift masks (AttPSM), alternating phase-shift masks (AltPSM), and curvilinear photomasks. In another embodiment, the one or more ML Models 125 may be neural networks, such as a convolutional neural network (CNN), a recurrent neural network (RNN), or any other suitable neural network architecture, trained using the dataset of mask works, corresponding optimized manufacturing process parameters, and end-of-line electrical performance parameters. As depicted in FIG. 1, the memory 120 is coupled to the one or more processors 130 for storing and retrieving data during the optimization process.

As depicted in FIG. 1, the one or more processors 130 are coupled to the memory 120 and the non-transitory computer-readable medium 140. The non-transitory computer-readable medium 140 stores instructions that, when executed by the one or more processors 130, cause the system 100 to perform the following steps, by way of example and not limitation:

Input the received mask work into the one or more ML Models 125. In one embodiment, the mask work may be preprocessed and formatted into a suitable input representation, such as a binary image, a grayscale image, or a vector representation, before being input into the one or more ML Models 125.

Generate, using the one or more ML Models 125, a set of optimized process parameters for a multi-step semiconductor manufacturing process based on the input mask work. According to an embodiment, the one or more ML Models 125 analyze the input mask work and generate a set of optimized process parameters that are predicted to produce a semiconductor device with the desired electrical performance characteristics. The optimized process parameters may include, but are not limited to, the type and concentration of cleaning agents, the spin speed and time for photoresist coating, the temperature and duration of photoresist baking, the wavelength and dose of exposure, the type and energy of ion implantation, the type and concentration of etching agents, the precursor gases and deposition parameters for CVD and PVD, the temperature and duration of thermal treatments, and the slurry composition and polishing parameters for CMP.

Generate, using the one or more ML Models 125, optimized process parameters for each layer of the received mask set. In another embodiment, the one or more ML Models 125 analyze each layer of the mask set and generate a set of optimized process parameters for each layer that are predicted to produce a semiconductor device with the desired electrical performance characteristics. The optimized process parameters for each layer may be different, depending on the specific pattern and features of each layer.

Simulate the multi-step semiconductor manufacturing process using the generated set of optimized process parameters. As depicted in FIG. 1, the system 100 includes a simulation module 141 that simulates the semiconductor manufacturing process using the optimized process parameters generated by the one or more ML Models 125. In one embodiment, the simulation module may use various simulation techniques, such as finite element analysis (FEA), computational fluid dynamics (CFD), or any other suitable simulation technique, to predict the outcome of the manufacturing process and verify that the optimized process parameters will generally produce a semiconductor device with the desired electrical performance characteristics.

Output the generated set of optimized process parameters. According to an embodiment, the optimized process parameters are output to the semiconductor manufacturing apparatus 150, which is configured to perform the multi-step semiconductor manufacturing process using the optimized process parameters. The semiconductor manufacturing apparatus 150 may include various manufacturing tools, such as cleaning tools, photoresist coating tools, photoresist baking tools, exposure tools, ion implantation tools, etching tools, CVD tools, PVD tools, thermal treatment tools, and CMP tools, that are typically controlled by the optimized process parameters. Alternatively, the optimized process parameters may also be output to the client device 160 or any other suitable device for further analysis or storage.

With reference to FIG. 1, the semiconductor manufacturing apparatus 150 is configured to manufacture the semiconductor device using the generated set of optimized process parameters. The apparatus 150 comprises at least one of a photolithography tool 151, such as a deep ultraviolet (DUV) or extreme ultraviolet (EUV) lithography system, an etching tool 152, such as a reactive ion etching (RIE) or plasma etching system, an ion implantation tool 153, such as a high-energy ion implanter, a chemical vapor deposition (CVD) tool 154, such as a low-pressure CVD (LPCVD) or plasma-enhanced CVD (PECVD) system, a physical vapor deposition (PVD) tool 155, such as a sputtering or evaporation system, an atomic layer deposition (ALD) tool 156, a thermal oxidation tool 157, such as a rapid thermal processing (RTP) system, or a chemical-mechanical polishing (CMP) tool 158, such as a rotary polishing system with abrasive slurry.

In one embodiment, these tools are interconnected via an automated material handling system 157 that transports semiconductor wafers between the various process chambers. The apparatus 150 further comprises metrology sensors or standalone metrology tools 161 configured to collect metrology data during the manufacturing of the semiconductor device. The metrology data includes, but is not limited to, data related to critical dimensions measured by a scanning electron microscope (SEM) or optical scatterometry, overlay measured by an overlay metrology tool, film thickness measured by ellipsometry or reflectometry, or defects detected by an optical inspection tool or electron beam inspection (EBI) system.

In some embodiments, the instructions stored in the non-transitory computer-readable medium 140 further cause the system 100 to:
1. Simulate the multi-step semiconductor manufacturing process using the generated set of optimized process parameters by running a virtual fabrication simulation using a technology computer-aided design (TCAD) tool that models the various process steps and their interactions. This simulation may include, but is not limited to, modeling the photolithography, etching, deposition, and planarization steps, as well as their respective process parameters and interactions.
2. Predict, by inputting the collected metrology data into the one or more ML Models 125, an end-of-line electrical performance parameter of the semiconductor device, wherein the end-of-line electrical performance parameter includes at least one of transistor threshold voltage, leakage current, or device speed. The prediction can also be based on the simulation of the multi-step semiconductor manufacturing process. In one embodiment, the one or more ML Models 125 are a neural network, such as a convolutional neural network (CNN) or recurrent neural network (RNN), trained on historical metrology and electrical test data. However, it is understood in the art that other types of ML models may be employed depending on the specific application and available data.
3. Determine that the predicted end-of-line electrical performance parameter substantially deviates from a target value, for example, if the predicted transistor threshold voltage is generally outside a specified range or if the predicted leakage current exceeds a maximum limit. The determination of deviation can be based on predefined tolerance levels or statistical process control limits.
4. Identify a root cause of the deviation of the predicted end-of-line electrical performance parameter from the target value by analyzing the metrology data and simulation results using statistical methods, such as regression analysis or principal component analysis (PCA), thereby isolating the key factors contributing to the deviation. This analysis may optionally involve data preprocessing techniques, including but not limited to, data normalization, feature scaling, and outlier removal, to improve the accuracy and robustness of the root cause identification.
5. Suggest a corrective action to address the identified root cause, such as adjusting a process parameter or performing a rework operation, based on predefined decision rules or optimization algorithms. The corrective action might be generated by one or more ML analysis algorithms 126. In some embodiments, the one or more ML analysis algorithms 126 are facilitated via a rule-based expert system, a genetic algorithm, or other optimization techniques, depending on the complexity of the manufacturing process and the desired performance targets.
6. Adjust a process parameter of the multi-step semiconductor manufacturing process based on the deviation to optimize the end-of-line electrical performance parameter, wherein adjusting the process parameter includes adjusting at least one of exposure dose in the photolithography tool 151, focus in the photolithography tool 151, etch time in the etching tool 152, etch gas composition in the etching tool 152, deposition temperature in the CVD tool 154, PVD tool 155, or ALD tool 156, or CMP pressure in the CMP tool 158. According to another embodiment, the system 100 is integrated with an advanced process control (APC) framework 162 that manages the overall factory operations and interfaces with the individual tools and metrology systems. The APC framework 162 can also include a real-time dispatcher configured to schedule wafer processing and metrology tasks based on the optimized process parameters and tool availability. By leveraging the capabilities of the system 100, semiconductor manufacturers can achieve tighter process control, faster yield ramp, and higher device quality, while reducing the cost and cycle time of process optimization. The process parameter adjustments are communicated to the relevant tools via the APC framework 162. In some cases, the adjustments may be made incrementally or iteratively to avoid overcorrection and maintain process stability.
7. Retrain the one or more ML Models 125 using the collected metrology data and corresponding end-of-line electrical performance parameters, thereby improving the accuracy of the model for future optimizations. In one embodiment, the retraining process is triggered periodically or when the model performance degrades below a threshold level. The retraining process can employ various techniques, such as batch learning, online learning, or transfer learning, based on the size and diversity of the available dataset and the computational resources at hand.

In one embodiment, the system 100 provides a closed-loop optimization solution for semiconductor manufacturing processes by integrating machine learning, real-time metrology data collection, and automated process parameter adjustment. In one embodiment, the one or more ML Models 125 learn from historical data and continuously adapt based on new metrology data to generate increasingly optimized process parameters. This enables the system 100 to proactively identify and correct deviations in end-of-line electrical performance parameters, ultimately improving yield and device performance.

In one embodiment, the system 100 is implemented using modern web technologies and frameworks. The user interface 300 is built with React, while the backend utilizes Python for data processing and integration with the ML models implemented using TensorFlow. Secure HTTPS protocols are employed for client-server communication, and the system 100 exposes well-defined APIs, such as RESTful or GraphQL, thereby enabling seamless integration with external systems, including the semiconductor manufacturing apparatus 150 and metrology tools 161. Additionally, the system 100 is integrated with the advanced process control (APC) framework 162. The APC framework 162 communicates with the system 100 through the exposed APIs, exchanging data and control signals to optimize the semiconductor manufacturing process

FIG. 2 illustrates a machine learning training process 200 for optimizing a semiconductor manufacturing process. As shown in FIG. 2, the training process 200 comprises a training data set 210, the one or more ML models 220, a loss function 230, an optimization algorithm 240, training epochs 250, and a validation data set 260.

With reference to FIG. 2, the training data set 210 includes input data 212 and corresponding output labels 214. In one embodiment, the input data 212 comprises a plurality of mask works defining patterns for semiconductor devices, along with associated manufacturing process parameters. In this embodiment, the mask works are represented as two-dimensional matrices of pixels, wherein each pixel value indicates a feature of the mask pattern at that location. The associated manufacturing process parameters included in the input data 212 may consist of: photolithography settings such as exposure dose (mJ/cm2), focus (nm), and mask bias (nm); etch process settings such as etch time(s), etch gas composition (sccm), and RF power (W); deposition process settings such as deposition temperature (° C.), precursor gas flow rates (sccm), and chamber pressure (Torr); and chemical-mechanical polishing (CMP) settings such as polishing pressure (psi), polishing time(s), and slurry composition.

According to an embodiment, the output labels 214 indicate optimal process parameters for each mask work, determined based on end-of-line electrical performance parameters of the manufactured semiconductor devices. These end-of-line parameters may include transistor threshold voltage (V), leakage current (nA), and device switching speed (GHz).

As depicted in FIG. 2, the one or more ML models 220 are configured to receive the input data 212 from the training data set 210 and generate predicted optimal process parameters 222. In one embodiment, the one or more machine learning models are convolutional neural networks (CNNs) adapted for pattern recognition in the mask works. In this embodiment, the CNNs comprise multiple convolutional layers 224 for extracting features from the input mask works, coupled to fully connected layers 226 for learning relationships between the extracted features and the optimal process parameters. The convolutional layers 224 apply learnable filters to the input mask work matrices, thereby detecting patterns and features at various spatial scales. The fully connected layers 226 are then configured to map these learned features to the predicted optimal process parameters 222, which are of the same format as the output labels 214 (i.e., photolithography settings, etch settings, deposition settings, CMP settings).

During a forward pass of the training process 200, the input data 212 is propagated through the convolutional layers 224 and fully connected layers 226 of the one or more CNNs, thereby generating the predicted optimal process parameters 222. The loss function 230, which may be a mean squared error or other suitable function, is configured to compute a loss value 232 by comparing the predicted optimal process parameters 222 to the output labels 214 from the training data set 210, wherein the loss value 232 quantifies the error in the predictions made by the one or more ML models 220. For example, in one embodiment, a mean squared error loss would calculate the average squared difference between each predicted process parameter value and its corresponding output label value.

In a backward pass, the loss value 232 is propagated back through the fully connected layers 226 and convolutional layers 224 of the one or more CNNs. In one embodiment, the optimization algorithm 240, such as stochastic gradient descent or Adam, is configured to compute gradients of the loss with respect to the model parameters (i.e., the weights and biases of the convolutional and fully connected layers) and update the parameters in the direction that minimizes the loss value 232. In one embodiment, the learning rate hyperparameter of the optimization algorithm 240 controls the step size of these parameter updates. This process of forward and backward propagation is repeated for a predetermined number of training epochs 250, wherein each epoch uses a different subset (mini-batch) of the training data set 210, until the one or more ML models 220 converge to a state where the loss value 232 is sufficiently low and the predicted optimal process parameters 222 closely match the output labels 214.

As illustrated in FIG. 2, the trained one or more ML models 125 are evaluated using the validation data set 260, wherein the validation data set 260 includes input mask works 262 and corresponding optimal process parameters 264 that were not used during the training process 200. The trained model 125 predicts optimal process parameters for the validation input mask works 262, and these predictions are compared to the validation optimal process parameters 264 to compute performance metrics 270. These metrics may include but are not limited to: accuracy, mean absolute error (MAE), root mean squared error (RMSE), and coefficient of determination (R2). These performance metrics 270 thereby provide an estimate of the trained model's ability to generalize to new, unseen mask works and to accurately predict optimal process parameters for them.

In one embodiment, the one or more trained ML model 125 can be deployed in the system 100 as the one or more ML models 125 disposed in memory 120. Once deployed, the one or more ML Models 125 can perform several key functions such as:
1. Generating optimized process parameters for new mask works. In one embodiment, when a new mask work is received via the input interface 110, it is input into the trained one or more ML Models 125. The one or more ML Models 125 predict the optimal photolithography, etch, deposition, and CMP settings to use when manufacturing a semiconductor device according to that mask work pattern. These predicted optimal settings are output and can be used to configure the tools of the semiconductor manufacturing apparatus 150 (e.g., the photolithography tool 151, the etching tool 152, the deposition tools 154-156, and the CMP tool 158) to automatically configure them for the new manufacturing process.
2. Predicting end-of-line electrical performance parameters. In another embodiment, the one or more ML Models 125 can also predict end-of-line electrical performance parameters for a manufactured semiconductor device, such as transistor threshold voltage, leakage current, and switching speed. This is facilitated by inputting metrology data collected from the semiconductor manufacturing apparatus 150 during the manufacturing process into the one or more ML Models 125, wherein the metrology data may comprise measurements of critical dimensions, overlay, film thickness, and defects at various stages of the manufacturing process. By learning the relationships between these in-line metrology measurements and the final electrical performance parameters during training, the one or more ML Models 125 can accurately predict end-of-line performance from the in-line data.
3. Identifying root causes of performance deviations and suggesting corrective actions. According to an embodiment, when the one or more ML Models 125 predict an end-of-line electrical performance parameter that deviates from a target value, the system 100 can help identify the root cause of the deviation and suggest corrective actions. This is done by analyzing the relationships learned by the one or more ML models 125 between process parameters, metrology data, and end-of-line performance. For example, if the one or more ML models 125 predict that a device will have higher-than-expected leakage current, the system 100 may determine that this is caused by an etch process that is not properly tuned.

In one embodiment, the system 100 arrives at this conclusion by examining the internal activation patterns and learned feature representations within the trained ML model 125 via ML analysis algorithms 126 stored in the memory 120 and executed by the one or more processors 130, wherein the system 100 analyzes the weights and activations of the neurons in the fully connected layers 226 that are most strongly associated with the predicted leakage current value. By tracing these activations back through the convolutional layers 224, the system 100 can identify which input features and process parameters have the greatest influence on the predicted leakage current. According to an embodiment, if the system 100 finds that the etch time or etch gas composition parameters are strongly correlated with the high leakage current prediction, it can infer that an improperly tuned etch process is the likely root cause of the performance deviation. In response, the system 100 may suggest adjusting the etch time or gas composition to correct the issue, thereby enabling this root cause analysis and corrective action suggestion to be performed by interpreting the internal parameters and learned features of the trained ML model 125.
4. Retraining on new data to improve accuracy and adapt to process drifts: In one embodiment, as the system 100 is used over time to manufacture semiconductor devices, new metrology data is continually collected from the manufacturing apparatus 150 and stored in the memory 120. Periodically, this new metrology data is added to the training data set 210 and used to retrain the one or more ML models 125. This retraining process is fundamentally the same as the initial training process 200 depicted in FIG. 2, but it starts from the already-trained weights of the one or more ML models 125 rather than from scratch. Retraining allows the one or more ML models 125 to continue to improve their predictive accuracy by learning from a larger and more diverse dataset, and to adapt to gradual drifts in the manufacturing process over time. Alternatively, the system 100 can automatically trigger a retraining of the one or more ML models 125 whenever a certain amount of new metrology data has been collected or on a periodic schedule.

In one embodiment of the training process 200, the input data 212 comprises 10,000 mask works for a 7 nm FinFET technology node, with each mask work represented as a 1024×1024 pixel grayscale image. The associated manufacturing process parameters included in the input data 212 consist of: photolithography settings (193 nm immersion lithography, 0.75 NA) with exposure dose ranging from 18-22 mJ/cm2, focus ranging from −20 to +20 nm, and mask bias from −10 to +10 nm; plasma etching settings (atomic layer etching) with etch time from 15-25 seconds, SF6 flow rate from 50-150 sccm, and RF power from 500-1500 W; atomic layer deposition settings for the high-k gate dielectric (HfO2) with deposition temperature from 200-300° C., precursor flow rate from 50-200 sccm, and chamber pressure from 1-10 Torr; and CMP settings for the replacement metal gate (RMG) process with polishing pressure from 1-5 psi, polishing time from 30-90 seconds, and slurry composition (pH 9-11). The output labels 214 indicate the optimal values for each of these process parameters that result in FinFET devices with threshold voltage of 0.3V±0.02V, leakage current <10 nA/μm, and switching delay <0.5 ps. The one or more ML models 220 are trained for 100 epochs with a batch size of 64 mask works, using the Adam optimizer with a learning rate of 0.001, to minimize the mean squared error loss between the predicted and labeled optimal process parameters.

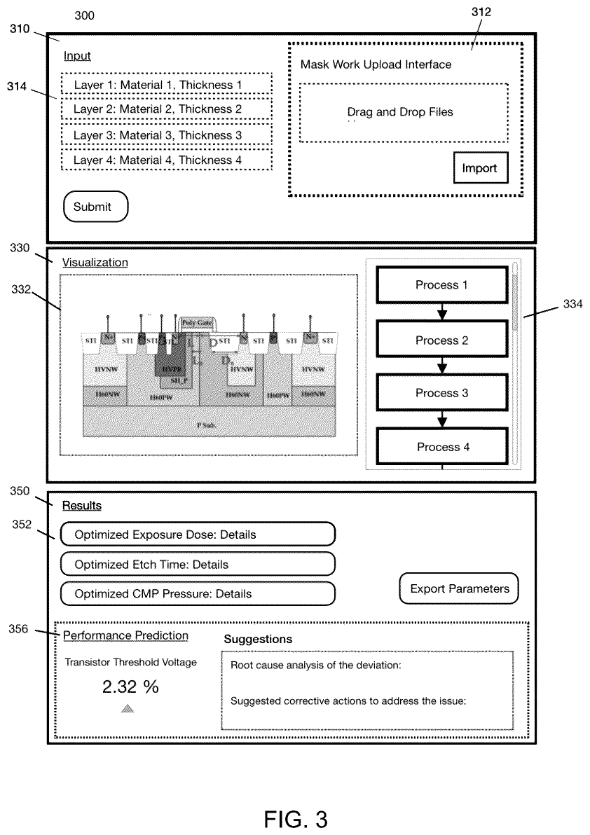

FIG. 3 illustrates a schematic diagram of a user interface 300 for interacting with the system 100 of FIG. 1 to optimize a semiconductor device manufacturing process. As shown in FIG. 3, the user interface 300 comprises an input section 310, a visualization section 330, and a results section 350.

In one embodiment, the input section 310 is configured to receive user input specifying parameters for a semiconductor device manufacturing process. The input section 310 includes a mask work upload interface 312 for receiving a mask work defining a pattern for a semiconductor device, as described with reference to the input interface 110 of FIG. 1. The mask work upload interface 312 allows a user to select and upload a mask work file from a client device 160.

The input section 310 further comprises a layer stack input 314 for receiving a mask set defining multiple layers of the semiconductor device, as discussed with reference to the input interface 110 of FIG. 1. The layer stack input 314 provides fields for specifying materials, thicknesses, and other properties of each layer in the semiconductor device.

Additionally, the input section 310 includes process parameter inputs 316 for specifying values of various manufacturing process parameters. In another embodiment, the process parameter inputs 316 may include further input fields (not shown) for specifying parameters such as exposure dose, focus, etch time, etch gas composition, deposition temperature, and CMP pressure, as described with reference to the process parameter adjustment in FIG. 1.

As depicted in FIG. 3, the input section 310 is operatively coupled to one or more ML models 125 stored in the memory 120 of the system 100. When a user submits the input data via the input section 310, the data is fed into the one or more ML models 125 to generate a set of optimized process parameters for manufacturing the specified semiconductor device.

The visualization section 330 of the user interface 300 is configured to display representations of the semiconductor device and manufacturing process. In one embodiment, the visualization section 330 includes an interactive device cross-section display 332 that presents a cross-sectional view of the layers and features of the semiconductor device. The cross-section display 332 is dynamically updated based on the layer stack and mask work inputs received via the input section 310. The visualization section 330 also includes a process flow diagram 334 that graphically depicts the sequence of steps in the manufacturing process. The process flow diagram 334 highlights the current step and provides estimated durations and key parameters for each step.

The results section 350 of the user interface 300 is configured to display the outputs generated by the one or more ML models 125 are based on the user inputs. As illustrated in FIG. 3, the results section 350 includes an optimized parameter output 352 that presents the set of optimized process parameters generated by the one or more ML models 125. In one embodiment, the optimized parameter output 352 may include suggested values for parameters such as exposure dose, focus, etch time, etch gas composition, deposition temperature, and CMP pressure, as described with reference to the output of optimized process parameters in FIG. 1.

In some embodiments, the results section 350 further comprises a metrology data display (not shown) that presents real-time metrology data collected during the semiconductor device manufacturing process by the semiconductor manufacturing apparatus 150. The metrology data may include measurements of critical dimensions, overlay, film thickness, and defects, as discussed with reference to the metrology data collection in FIG. 1.

Additionally, the results section 350 includes an electrical performance prediction 356 that displays an end-of-line electrical performance parameter of the semiconductor device predicted by the one or more ML models 125 based on the collected metrology data. The electrical performance prediction 356 may display parameters such as transistor threshold voltage, leakage current, and device speed. In another embodiment, if the predicted performance parameter deviates from a target value, the results section 350 may display a root cause analysis and suggested corrective actions, as described with reference to the deviation determination, root cause identification, and corrective action suggestion in FIG. 1.

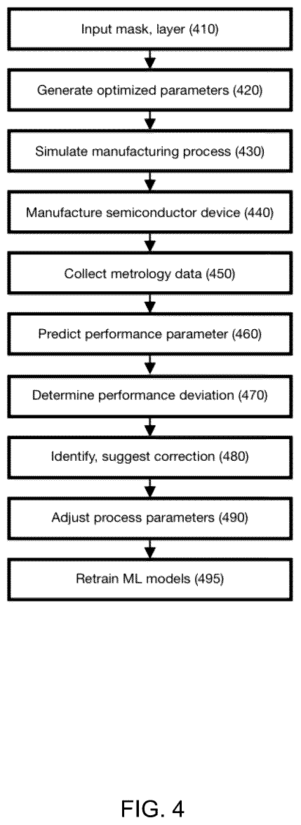

FIG. 4 illustrates a method 400 that may be employed for optimizing a semiconductor device manufacturing process using the system 100 of FIG. 1 via the user interface 300 of FIG. 3. The method 400 comprises steps for inputting data, generating optimized parameters, manufacturing the device, collecting metrology data, predicting performance, and adjusting parameters to improve end-of-line electrical performance.

As shown in FIG. 4, the method 400 generally begins with step 410, wherein a user may input a mask work and layer stack data via the input section 310 of the user interface 300. The mask work is typically received by the mask work upload interface 312 and defines a pattern for the semiconductor device. The layer stack data is often received by the layer stack input 314 and substantially defines the multiple layers of the semiconductor device. For example, the mask work could be a photomask design file defining the device pattern, and the layer stack data might include a silicon substrate, a 100 nm silicon dioxide (SiO2) layer, a 50 nm polysilicon layer, and a 200 nm silicon nitride (Si3N4) layer. In some embodiments, the user might also input initial process parameter values via the process parameter inputs 316, such as an exposure dose of 20 mJ/cm2, a focus of 0.2 μm, and an etch time of 60 seconds.

In step 420, the input mask work and layer stack data are generally fed into one or more ML models 125 that may be stored in the memory 120 of the system 100. The one or more ML models 125 can generate a set of optimized process parameters for a multi-step semiconductor manufacturing process based on the input data. According to an embodiment, the one or more ML models 125 may generate optimized process parameters for each layer substantially defined in the layer stack data. For example, the ML models 125 might generate an optimized exposure dose of 22 mJ/cm2, a focus of 0.18 μm, an etch time of 55 seconds, a deposition temperature of 400° C., and a CMP pressure of 5 psi. The optimized process parameters are typically output and displayed to the user via the optimized parameter output 352 in the results section 350 and the visualization section 330 of the user interface 300.

Step 430 may involve simulating the multi-step semiconductor manufacturing process using the optimized process parameters generated by the one or more ML models 125, wherein the simulation results can be used to predict end-of-line electrical performance parameters of the semiconductor device. For instance, the simulations using the optimized parameters might predict a transistor threshold voltage of 0.4V, a leakage current of 10 nA/μm, and a device speed of 3 GHz.

At step 440, the semiconductor device is generally manufactured by the semiconductor manufacturing apparatus 150 using the optimized process parameters output by the one or more ML models 125.

At step 450, real-time metrology data may be collected by the semiconductor manufacturing apparatus 150. In one embodiment, the metrology data can include, but is not limited to, measurements of critical dimensions, overlay, film thickness, and defects. For example, the metrology data might measure a critical dimension of 45 nm±2 nm, an overlay of 5 nm±1 nm, an SiO2 thickness of 98 nm±3 nm, and a defect density of 0.1 defects/cm2. The collected metrology data is typically displayed to the user via the metrology data display (not shown) in the results section 350 of the user interface 300.

In step 460, the collected metrology data is generally input into the one or more ML models 125 to predict an end-of-line electrical performance parameter of the manufactured semiconductor device. In another embodiment, the predicted performance parameter may include, without limitation, transistor threshold voltage, leakage current, or device speed. For instance, inputting the metrology data, the ML models might predict a transistor threshold voltage of 0.38V, a leakage current of 12 nA/μm, and a device speed of 2.8 GHz. The predicted performance parameter is typically displayed via the electrical performance prediction 356 in the user interface 300.

Step 470 may involve determining whether the predicted end-of-line electrical performance parameter substantially deviates from a target value. If a deviation is detected, the method generally proceeds to step 480, wherein a root cause of the deviation can be identified and a corrective action may be suggested, thereby enabling the user to take appropriate measures. For example, if the predicted threshold voltage of 0.38V deviates from the 0.4V target, a root cause analysis might suggest the focus is slightly off, and the corrective action could be to adjust the focus by +0.02 μm. The root cause and corrective action are often displayed to the user via the results section 350 of the user interface 300.

Based on the deviation and suggested corrective action, one or more process parameters may be adjusted in step 490 to optimize the end-of-line electrical performance parameter. In one embodiment, the adjustments can include, but are not limited to, modifying the exposure dose, focus, etch time, etch gas composition, deposition temperature, or CMP pressure. Continuing the example, the focus might be adjusted to 0.20 μm based on the suggested corrective action. The adjusted process parameters are generally fed back into the semiconductor manufacturing apparatus 150 to update the manufacturing process, thereby closing the optimization loop.

Finally, as depicted in FIG. 4, in step 495, the one or more ML models 125 may be retrained using the newly collected metrology data. This allows the one or more ML models 125 to continuously learn and adapt based on real-world manufacturing data, thereby improving their accuracy and performance over time. If the design is out of house of the manufacturer then there would be a design for manufacture review or purchase review for security.

Based on the detailed description provided herein, a skilled artisan would be able to re-create the claimed invention without undue experimentation. The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A method for optimizing a semiconductor device manufacturing process using an artificial intelligence (AI) system, comprising:
a. providing a mask work defining a pattern for a semiconductor device;
b. inputting the mask work into an AI system comprising one or more machine learning (ML) models trained on a dataset of mask works and corresponding optimized manufacturing process parameters;
c. generating, by the AI system, a set of optimized process parameters for a multi-step semiconductor manufacturing process based on the input mask work, the multi-step semiconductor manufacturing process including at least one of:
i. photolithography,
ii. etching,
iii. ion implantation,
iv. chemical vapor deposition (CVD),
v. physical vapor deposition (PVD),
vi. atomic layer deposition (ALD),
vii. thermal oxidation, or
viii. chemical-mechanical polishing (CMP);
d. manufacturing the semiconductor device using the generated set of optimized process parameters;
e. obtaining, during the manufacturing of the semiconductor device, metrology data from the semiconductor device;
f. predicting, by inputting the metrology data into the one or more ML models, an end-of-line electrical performance parameter of the semiconductor device;
g. determining that the predicted end-of-line electrical performance parameter deviates from a target value;
h. adjusting, by the AI system, a process parameter of the multi-step semiconductor manufacturing process based on the deviation to optimize the end-of-line electrical performance parameter; and
i. retraining the one or more ML Models using the obtained metrology data to improve the performance of the AI system over time.

2. The method of claim 1, wherein the mask work defines a curvilinear pattern for the semiconductor device, and wherein the AI system is trained on a dataset including curvilinear mask works.

3. The method of claim 1, wherein the multi-step semiconductor manufacturing process further includes at least one of:
a. wet cleans,
b. surface passivation,
c. plasma ashing,
d. rapid thermal processing (RTP),
e. millisecond thermal processing,
f. laser anneal, or
g. furnace anneals.

4. The method of claim 1, wherein the metrology data includes at least one of:
a. critical dimension (CD) measurements,
b. overlay measurements,
c. film thickness measurements, or
d. defect inspection data.

5. The method of claim 1, wherein the end-of-line electrical performance parameter includes at least one of:
a. threshold voltage,
b. saturation current,
c. leakage current, or
d. operating frequency.

6. The method of claim 1, wherein adjusting the process parameter of the multi-step semiconductor manufacturing process includes modifying at least one of:
a. exposure dose in the photolithography step,
b. etch time in the etching step,
c. implantation dose in the ion implantation step,
d. deposition time in the CVD, PVD, or ALD steps,
e. oxidation time in the thermal oxidation step, or
f. polishing time in the CMP step.

7. The method of claim 1, further comprising:
a. wafer testing to verify electrical performance of the manufactured semiconductor device;
b. die preparation of the manufactured semiconductor device; and
c. IC packaging of the manufactured semiconductor device.

8. A system for optimizing a semiconductor device manufacturing process, comprising:
a. an input interface configured to receive a mask work defining a pattern for a semiconductor device;
b. a memory storing one or more machine learning (ML) models trained on a dataset of mask works and corresponding optimized manufacturing process parameters;
c. one or more processors;
d. a non-transitory computer-readable medium storing instructions that, when executed by the one or more processors, cause the system to:
i. input the received mask work into the one or more ML Models,
ii. generate, using the one or more ML Models, a set of optimized process parameters for a multi-step semiconductor manufacturing process based on the input mask work, and
iii. output the generated set of optimized process parameters;
e. a semiconductor manufacturing apparatus configured to:
i. manufacture the semiconductor device using the generated set of optimized process parameters, the semiconductor manufacturing apparatus including at least one of:
1. a photolithography tool,
2. an etching tool,
3. an ion implantation tool,
4. a chemical vapor deposition (CVD) tool,
5. a physical vapor deposition (PVD) tool,
6. an atomic layer deposition (ALD) tool,
7. a thermal oxidation tool, or
8. a chemical-mechanical polishing (CMP) tool, and
ii. collect metrology data during the manufacturing of the semiconductor device; and
f. wherein the instructions further cause the system to:
i. predict, by inputting the collected metrology data into the one or more ML Models, an end-of-line electrical performance parameter of the semiconductor device,
ii. determine that the predicted end-of-line electrical performance parameter deviates from a target value,
iii. adjust a process parameter of the multi-step semiconductor manufacturing process based on the deviation to optimize the end-of-line electrical performance parameter, and
iv. retrain the one or more ML Models using the collected metrology data.

9. The system of claim 8, wherein the dataset of mask works and corresponding optimized manufacturing process parameters includes data related to at least one of cleaning, photoresist coating, photoresist baking, exposure, ion implantation, etching, chemical vapor deposition (CVD), physical vapor deposition (PVD), thermal treatments, or chemical-mechanical polishing (CMP).

10. The system of claim 8, wherein the one or more ML Models are configured to generate optimized process parameters for a curvilinear photomask.

11. The system of claim 8, wherein the instructions further cause the system to:
a. receive a mask set defining multiple layers of the semiconductor device; and
b. generate, using the one or more ML Models, optimized process parameters for each layer of the mask set.

12. The system of claim 8, wherein the metrology data includes data related to at least one of critical dimensions, overlay, film thickness, or defects.

13. The system of claim 8, wherein the end-of-line electrical performance parameter includes at least one of transistor threshold voltage, leakage current, or device speed.

14. The system of claim 8, wherein adjusting the process parameter includes adjusting at least one of exposure dose, focus, etch time, etch gas composition, deposition temperature, or CMP pressure.

15. The system of claim 8, wherein the one or more ML Models comprise a neural network trained using a dataset of mask works, corresponding optimized manufacturing process parameters, and end-of-line electrical performance parameters.

16. The system of claim 8, wherein the instructions further cause the system to:
a. simulate the multi-step semiconductor manufacturing process using the generated set of optimized process parameters; and
b. predict the end-of-line electrical performance parameter based on the simulation.

17. The system of claim 8, wherein the instructions further cause the system to:
a. identify a root cause of the deviation of the predicted end-of-line electrical performance parameter from the target value; and
b. suggest a corrective action to address the root cause.
